(19) United States
(12) Patent Application Publication
(10) Pub. No.: US 2018/0159110 A1
(43) Pub. Date: Jun. 7, 2018

(54) ELECTRIC VEHICLE BATTERY SAFETY

(71) Applicant: TANKTWO OY, Vantaa (FI)

(72) Inventor: Juha TUOMOLA, Vantaa (FI)

(21) Appl. No.: 15/569,961

(22) PCT Filed: Apr. 22, 2016
(86) PCT No.: PCT/EP2016/059058

§ 371 Date: Oct. 27, 2017

(30) Foreign Application Priority Data
Apr. 28, 2015 (GB) 1507220.0

(51) Int. Cl. H01M 2/34; H01M 2/10; H01M 10/42; H01M 10/48; H01M 10/625; B60K 1/04; B60L 3/00; B60L 3/04; B60L 11/18

(52) U.S. Cl. CPC H01M 2/348; B60Y 2306/01; H01M 10/4207; H01M 10/486; H01M 10/625; B60K 1/04; B60L 3/0007; B60L 3/0046; B60L 3/04; B60L 11/1877; B60L 11/1879; H01M 2010/4278; H01M 2220/20; B60K 2001/0438; B60K 2001/0472; B60L 2240/545; H01M 2/1077

(57) ABSTRACT

An electrical energy supply system for use in an electric vehicle. The electrical energy supply system comprises a tank configured to contain a multiplicity of batteries which are not fastened to each other, and configured to deliver electrical energy from the batteries to other systems of the vehicle, the tank comprising a release system configured to release or otherwise disperse some or all of the batteries from the tank. The system further comprises a detector configured to detect undesirable heating or thermal runaway of a battery within the multiplicity of batteries, and to cause the release system to release the batteries in response to detecting said undesirable heating or thermal runaway.

### TECHNICAL FIELD

The present invention relates to an electrical energy storage and supply system for an electric vehicle. In particular, it relates to such an electrical energy storage and supply system configured to improve the safety of the vehicle, and a corresponding method.

### BACKGROUND

An important aspect of automobile safety is keeping on-board hazardous materials safe. For example, in a gasoline powered car, systems are used to prevent the gasoline igniting in the event of a crash. Such fires are now relatively rare.

In electric vehicles, the energy source is typically a number of battery packs. In many cases, these battery packs use lithium or lithium-ion cells, which are very reactive and can ignite or explode in case of malfunction. Lithium and lithium-ion cells can suffer from thermal runaway, which means that if a single cell in a pack overheats, it is likely to cause other cells to overheat as well, and the positive feedback may cause the entire pack to ignite. Additionally, lithium fires are extremely difficult to extinguish. These problems may also be present in hybrid vehicles, which use both batteries and other energy sources.

Energy sources for electric and hybrid vehicles may consist of a few large battery packs, or they may consist of a large number of small cells such as described in GB2518196 and GB2518197 assigned to Tanktwo Oy, Vantaa, Finland.

### SUMMARY

According to a first aspect of the present invention there is provided an electrical energy supply system for use in an electric vehicle. The electrical energy supply system comprises a tank configured to contain a multiplicity of batteries which are not fastened to each other, and configured to deliver electrical energy from the batteries to other systems of the vehicle, the tank comprising a release system configured to release or otherwise disperse some or all of the batteries from the tank. The system further comprises a detector configured to detect undesirable heating or thermal runaway of a battery within the multiplicity of batteries, and to cause the release system to release the batteries in response to detecting said undesirable heating or thermal runaway.

The term “fastened” is intended to mean “mechanically secured together”. Typically, batteries of the electrical energy supply system are maintained in contact with their neighbours by merely being contained within the tank at a sufficient density. Some additional non-mechanical means may be used to maintain contact, e.g. a means to pressurise the tank interior.

Embodiments of the invention are able to detect overheating or thermal runaway in one or a small number of batteries contained within the tank and to cause release or dispersement of the batteries in response. This easily achievable because the batteries are not fixed together and no mechanical disconnection between batteries is required. This avoids a chain reaction spreading through the battery tank. Assuming that the batteries are relatively small, individually having a relatively small energy storage capacity, the resulting damage/danger is very limited avoiding, for example, a vehicle fire or the release of dangerously high levels of toxic fumes.

The detector may comprise a temperature sensor located within each battery and an external controller in communication with the multiplicity of sensors for receiving temperature information therefrom, the external controller being responsive to said information to cause the release system to release in the event that thermal runaway of a battery is detected. The external controller communicates with the sensors via radio signalling or using data modulated onto power signals passing through the batteries.

The release system may comprise a portion of the tank configured to open and allow the batteries to fall out of the tank due to gravity, wherein the portion of the tank is configured to open by tearing along a pre-weakened section. The release system comprises a pressurised gas source configured to release pressurised gas into the tank, and the portion of the tank is configured to open due to the pressure exerted by the pressurised gas. The pressurised gas source is configured to release the pressurised gas into an airbag within the tank.

In an alternative embodiment, the release system comprises a pyrotechnic charge.

The release system may comprise a latch mechanism configured to releasably secure a portion of the tank in a closed position, wherein releasing the batteries comprises releasing the portion of the tank.

The tank may be configured to contain the batteries in an essentially random order and orientation, each battery comprising an electric energy reservoir having positive and negative voltage supply terminals, three or more electric contact pads on an outer surface of the battery, and a dynamically configurable connection unit for electrically connecting each of said positive and negative voltage supply terminals to any one or more of said electric contact pads, wherein electric energy can be drawn from the electric energy reservoir via selecting different combinations of electric contact pads.

According to a second aspect of the present invention there is provided a method of operating an electric vehicle, the vehicle being powered by a multiplicity of batteries contained within a tank and which batteries are not fastened to each other. The method comprises detecting thermal runaway or overheating of any one of the batteries, and in response to detecting said thermal runaway or overheating, releasing or otherwise dispersing some or all of the batteries from the tank.

The step of releasing the batteries from the vehicle may comprise opening a portion of a tank containing the batteries and allowing the batteries to fall out due to gravity.

The step of opening a portion of the tank may comprise releasing pressurised gas into the tank in order to cause the portion of the tank to open. For example, the pressurised gas may be released into an airbag.

The step of opening a portion of the tank may comprise releasing a latch mechanism configured to secure the portion of the tank in a closed position.

According to a third aspect of the present invention there is provided vehicle comprising an electrical energy supply system according to the first aspect of the invention.

According to a further aspect of the invention, there is provided an electrical energy supply system for use in an electric vehicle. The electrical energy supply system comprises a tank and a detector. The tank is configured to contain a multiplicity of batteries which are not fastened to each other, and configured to deliver electrical energy from the batteries to other systems of the vehicle, the tank comprising a release system configured to release the batteries from the tank and from the vehicle. The detector is configured to detect a condition of the vehicle and/or the batteries which could cause the batteries to become hazardous, and to cause the release system to release the batteries in response to detecting said condition.

According to a still further aspect, there is provided a method of operating an electric vehicle, the vehicle being powered by a multiplicity of batteries which are not fastened to each other. The method comprises detecting a condition of the vehicle and/or the batteries which could cause the batteries to become hazardous; and, in response to detecting said condition, releasing the batteries from the vehicle.

According to a still further aspect, there is provided a vehicle comprising an electrical energy supply system according to the first aspect.

### BRIEF DESCRIPTION OF THE DRAWINGS

FIG. 1 is a schematic diagram of an energy storage and supply system;

FIG. 2 is a schematic diagram of a battery unit;

FIG. 3 shows a tank according to an example;

FIG. 4 shows a tank according to a further example;

FIG. 5 shows a tank according to a further example;

FIG. 6 shows a vehicle according to a further example;

FIG. 7 shows a flowchart of a method according to a further example, and

FIG. 8 shows a flowchart of a method according to a still further example.

### DETAILED DESCRIPTION

In a system with a multiplicity of batteries, sensing of temperature and/or electrical properties on an individual battery level can be used to detect thermal runaway of a battery before it becomes dangerous. Such thermal runaway may be caused by defects in the battery, or by external factors such as a cooling failure or a crash.

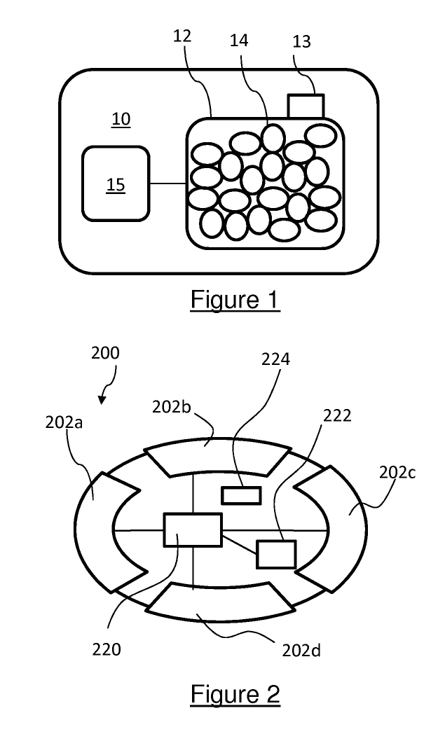

FIG. 1 is a schematic illustration of an energy storage and supply system for an apparatus 10. The system comprises a tank 12, containing a multiplicity of battery units 14. Connections between the battery units 14 and the tank are governed by a controller 13 and/or controllers of the battery units. The battery units supply electrical power via the tank 12 to a load 15. Such an architecture is described generally in the GB patent publications referenced above.

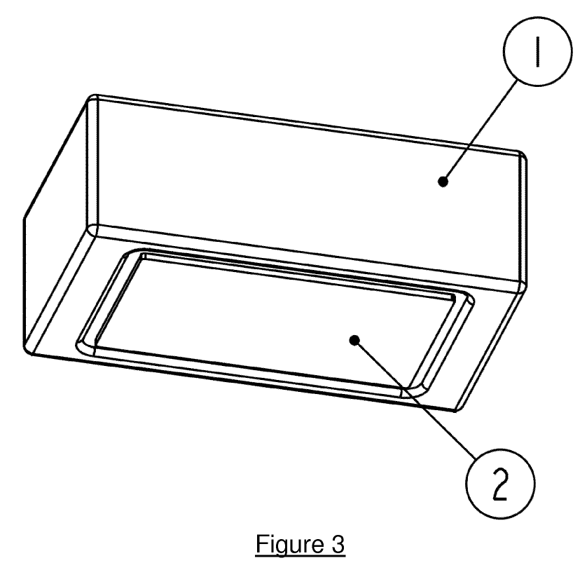

FIG. 2 is a schematic illustration of a battery unit. Each battery unit 200 has a temperature sensor 224 and an electric energy reservoir 222. The electric energy reservoir has positive and negative terminals, which can be connected to any contact point 202 a-d on the outer surface of the battery by a control unit 220. Temperature and electrical properties of the battery unit are measured, and these measurements are used to detect thermal runaway of the battery unit. The detection may occur in the control unit of the battery unit, or the temperature and electrical properties measurements may be passed to an external control unit which makes the detection, e.g. the control unit of a tank containing the battery units. The control units 220 of the individual batteries may exchange information with an external control unit via any suitable mechanism. For example, wireless signalling (e.g. radio) may be used, or information may be encoded onto the power supply provided by a string of batteries.

If thermal runaway is detected, the electrical output of the battery unit may be varied in order to prevent the runaway. For example, the output voltage and/or current may be varied, the duty cycle of the battery unit may be adjusted, or the electric energy reservoir may be disconnected from any load. The disconnection may be achieved by the battery control unit disconnecting the electrical energy reservoir from the contact points, and optionally placing the battery unit into a “bypass mode” where the contact points are connected to each other but not to the reservoir. Alternatively, the disconnection may be achieved by an external control unit causing a set of batteries of which the battery unit undergoing thermal runaway is a member to be disconnected. For example, in a system such as that presented in GB2518196, where the battery units are formed into “strings”, a single string may be disconnected or reconfigured (to eliminate the problem battery unit). By actively monitoring a battery unit following disconnection, it may later be possible to bring the battery back into use if it is safe to do so.

Alternatively, the disconnection may be achieved by physically separating the battery unit from other battery units and/or tank contact pads. This may be done by releasing the battery unit or a set of battery units comprising the battery unit from the tank. Physically separating the battery unit disconnects it from the load, and allows the battery unit to cool faster, and prevents thermal runaway in one battery unit from causing thermal runaway in other battery units due to heat transfer. Releasing the battery units from the tank will further improve cooling as they will scatter and be cooled by the ambient surroundings. Even if the thermal runaway is not stopped by this, it is unlikely to spread to other batter units, and since the battery unit is outside the tank, it is unlikely to damage other components. For example, in an electric vehicle, the overheating battery unit will be below the vehicle, and the energy stored in an individual battery unit of the multiplicity of battery units is unlikely to cause significant damage when located below the vehicle (as opposed to in the tank, where it is much closer to sensitive components, and may cause thermal runaway of other battery units). Other mechanisms for dispersing batteries are also contemplated. For example, batteries may be released (including partial release) into a secondary tank or storage area.

The release may be accomplished by removing a support for the batteries, allowing them to fall from the vehicle under gravity, for example a floor of the tank in which the batteries are placed may be configured to fall away in the event of a crash. Alternatively or additionally, an active ejection mechanism such as a spring-loaded mechanism or an airbag could be provided to forcefully expel the batteries from the vehicle.

FIG. 3 shows an exemplary tank 1. The tank has a floor 2 configured to open (e.g. by detaching, falling away, or hinging open) in the event of a crash. This may be achieved in a variety of ways, as exemplified by FIGS. 2 through 4. The tank is part of an electrical energy and supply system of the vehicle, and is configured to contain the batteries, and configured to deliver energy from the batteries to other systems of the vehicle.

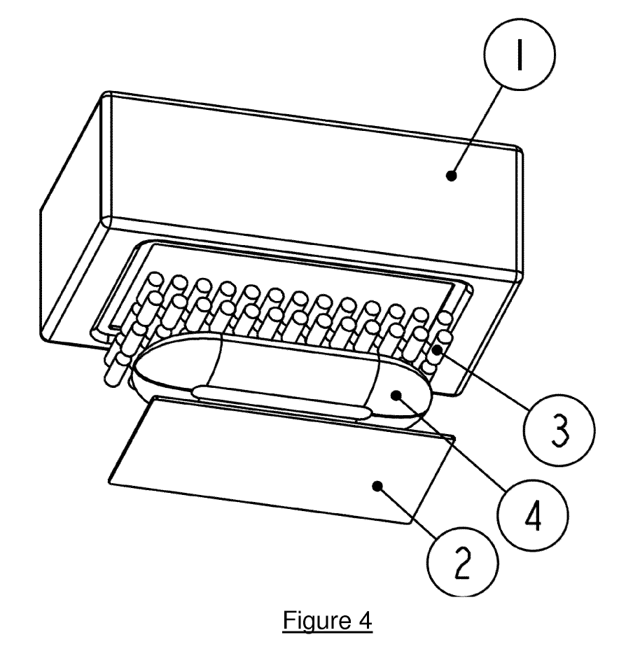

FIG. 4 shows a method making use of an airbag 4. The airbag 4 is placed inside the tank 1, either adjacent to the floor 2 or otherwise, in such a way that when the airbag inflates, it puts sufficient pressure on the floor 2 to cause the floor 2 to detach from the tank 1, e.g. due to pre-weakened seams in the floor 2. The batteries 3 then fall out from the tank. As an alternative, high pressure gas may be pumped into the tank 1 itself, so that the pressure causes the floor to detach. It is noted that nitrogen (as is used in most airbags) reacts with lithium, so an alternative inert gas such as argon should be used.

Alternatively, the floor of the tank may be held up by a releasable latch mechanism such as a solenoid or other actuator, with the latch mechanism configured to release the floor of the tank in the event of a crash. Optionally, the actuator may be additionally configured to release the floor of the tank in the event of a loss of power, or a spike in power, either of which could indicate a battery fault.

As a further alternative, a pyrotechnic charge could be used to rupture the tank, allowing the batteries to fall out.

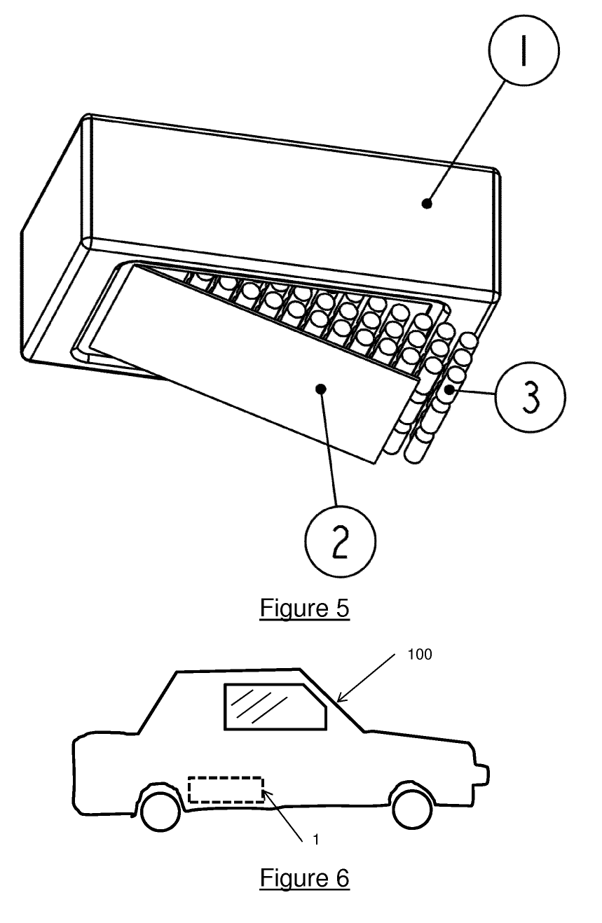

While the above embodiments have referred to the floor detaching, the floor may also be hinged to allow it to release the batteries without detaching, as shown in FIG. 5.

While the embodiments described above refer to the floor of the tank detaching or falling away, other methods of opening the tank to release the batteries inside may be used. For example the tank may be provided with a sloped floor, and a side of the tank at the base of the slope may open to allow the batteries to fall out, or a suitable means may be provided to eject the batteries from the vehicle.

The release mechanism may be configured to eject only a portion of the battery units, e.g. the tank may be split into sections, with a release mechanism for each section, so that when thermal runaway is detected the release mechanism for the section in which the thermal runaway is detected is activated, but the tank can continue to supply power from other sections.

FIG. 6 shows an electric vehicle containing a tank as described above. The tank is positioned such that batteries released from the tank will be released from the vehicle. Alternatively, the release system may cause the batteries to be released from the vehicle as well as from the tank (e.g. by providing a channel for the batteries to exit the vehicle, such as by opening a section of the floor of the vehicle).

Historical data about the battery units may be recorded within the battery units. For example, if the battery unit undergoes thermal runaway, a software flag may be set within the battery unit, and battery units for which the flag is set may be prevented from being connected to a load (as they are likely faulty). The flag may be removed when the fault is repaired. As a further example, historical measurements of temperature and/or electrical properties may be recorded. The detection of thermal runaway may be based in part on these historical measurements, e.g. with batteries for which the historical measurements show a high amount of wear being subject to more sensitive detection, and batteries which show little wear being allowed to run closer to performance limits. Where the historical measurements show a high likelihood of thermal runaway, the electrical energy storage may be prevented from connecting to a load.

The detection of thermal runaway may also be based on the type of battery unit, e.g. with higher performance battery units being allowed greater temperature variations.

The detection of thermal runaway may include the detection of faults which would be expected to cause future thermal runaway. For example, if a battery unit shows an unusual voltage drop at peak load, the output of the battery unit may be varied as described above as such a behaviour may indicate that the internal resistance has increased, and so the battery is likely to overheat.

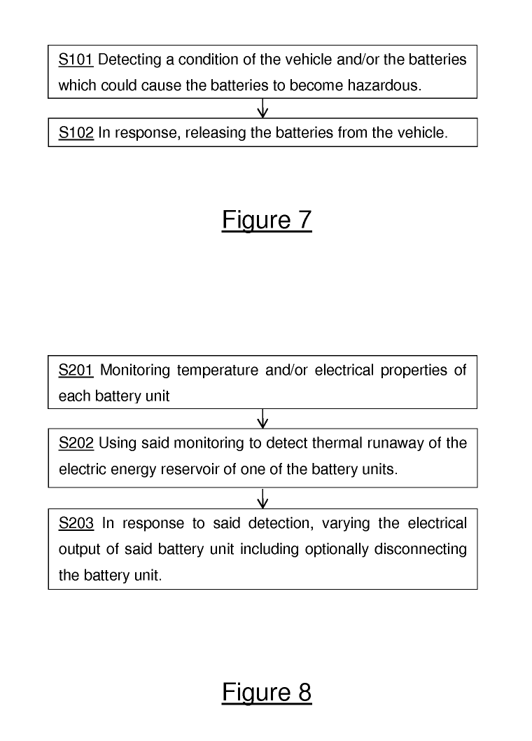

FIG. 7 is a flowchart of a method of operating an electric vehicle which is powered by a multiplicity of batteries which are not fastened to each other. A condition of the vehicle and/or the batteries which could cause the batteries to become hazardous is detected S101, and in response the batteries are released from the vehicle S102.

FIG. 8 is a flowchart of a method of operating an energy storage and supply system as described above. In step S201, the temperature and/or electrical properties of each battery unit in the system are monitored. In step S202, the monitoring is used to detect thermal runaway or potential thermal runaway of the electric energy reservoir of one of the battery units. In step S203, the electrical output of the battery unit is varied in response to the detection.

Where the term “multiplicity” is used above, this refers to a relatively large number of battery units, e.g. at least 10, at least 20, at least 50, or at least 100, in contrast to conventional systems which may use 1-4 large batteries.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. An electrical energy supply system for use in an electric vehicle, the electrical energy supply system comprising:
a tank configured to contain a multiplicity of batteries which are not fastened to each other, and configured to deliver electrical energy from the batteries to other systems of the vehicle, the tank comprising a release system configured to release or otherwise disperse some or all of the batteries from the tank; and
a detector configured to detect undesirable heating or thermal runaway of a battery within the multiplicity of batteries, and to cause the release system to release the batteries in response to detecting said undesirable heating or thermal runaway.

2. The system according to claim 1, wherein said detector comprises a temperature sensor located within each battery and an external controller in communication with the multiplicity of sensors for receiving temperature information therefrom, the external controller being responsive to said information to cause the release system to release in the event that thermal runaway of a battery is detected.

3. The system according to claim 2, wherein the external controller communicates with the sensors via radio signalling or using data modulated onto power signals passing through the batteries.

4. The system according to claim 1, wherein the release system comprises a portion of the tank configured to open and allow the batteries to fall out of the tank due to gravity.

5. The system according to claim 4, wherein the portion of the tank is configured to open by tearing along a pre-weakened section.

6. The system according to claim 4, wherein the release system comprises a pressurised gas source configured to release pressurised gas into the tank, and the portion of the tank is configured to open due to the pressure exerted by the pressurised gas.

7. The system according to claim 6, wherein the pressurised gas source is configured to release the pressurised gas into an airbag within the tank.

8. The system according to claim 1, wherein the release system comprises a pyrotechnic charge.

9. The system according to claim 1, wherein the release system comprises a latch mechanism configured to releasably secure a portion of the tank in a closed position, and releasing the batteries comprises releasing the portion of the tank.

10. The system according to claim 1, wherein the tank is configured to contain the batteries in an essentially random order and orientation, each battery comprising an electric energy reservoir having positive and negative voltage supply terminals, three or more electric contact pads on an outer surface of the battery, and a dynamically configurable connection unit for electrically connecting each of said positive and negative voltage supply terminals to any one or more of said electric contact pads, wherein electric energy can be drawn from the electric energy reservoir via selecting different combinations of electric contact pads.

11. A method of operating an electric vehicle, the vehicle being powered by a multiplicity of batteries contained within a tank and which batteries are not fastened to each other, the method comprising:
detecting thermal runaway or overheating of any one of the batteries; and
in response to detecting said thermal runaway or overheating, releasing or otherwise dispersing some or all of the batteries from the tank.

12. The method according to claim 11, wherein releasing the batteries from the vehicle comprises opening a portion of a tank containing the batteries and allowing the batteries to fall out due to gravity.

13. The method according to claim 12, wherein opening a portion of the tank comprises releasing pressurised gas into the tank in order to cause the portion of the tank to open.

14. The method according to claim 13, wherein the pressurised gas is released into an airbag.

15. The method according to claim 12, wherein opening a portion of the tank comprises releasing a latch mechanism configured to secure the portion of the tank in a closed position.

16. A vehicle comprising an electrical energy supply system according to claim 1.
